(19) United States
(12) Patent Application Publication
(10) Pub. No.: US 2024/0295671 A1
(43) Pub. Date: Sep. 5, 2024

(54) Ball-Loading Device For Fee Fall Experiment

(71) Applicant: NATIONAL UNIVERSITY OF DEFENSE TECHNOLOGY, Changsha, Hunan (CN)

(72) Inventors: Haobin ZHENG, Changsha, Hunan (CN); Jian LUO, Changsha, Hunan (CN); Yangjianming OU, Changsha, Hunan (CN); Gang PENG, Changsha, Hunan (CN); Yong WANG, Changsha, Hunan (CN); Weimeng SUN, Changsha, Hunan (CN); Zhenyu PENG, Changsha, Hunan (CN); Liansheng MENG, Changsha, Hunan (CN)

(21) Appl. No.: 18/276,949

(22) PCT Filed: Sep. 26, 2022
(86) PCT No.: PCT/CN2022/121188

§ 371 Date: May 28, 2024

(30) Foreign Application Priority Data
Sep. 29, 2021 (CN) 202122380403.1

(51) Int. Cl. G01V 7/02; G01V 7/14

(52) U.S. Cl. CPC G01V 7/02; G01V 7/14

(57) ABSTRACT

The ball-loading device for free-fall experiments includes an inlet tube and a shell. The first end of the shell is connected to the inlet tube, and the shell has a ball channel. A ball outlet is located at the second end of the shell, with the first end of the inlet shell positioned higher than the second end. Additionally, a bracket is rotatably connected to the shell and has a first blocking part and a second blocking part. As the bracket rotates around the shell, the first blocking part is switched to block the ball outlet, or the second blocking part is switched to block the ball channel. This device provided by the present disclosure allows automatic loading and resetting of the balls used in free fall experiments, thereby improving experimental efficiency.

### BACKGROUND

### Field of Disclosure

The present disclosure relates to a technical field of teaching experiment equipment, and more particularly to a ball-loading device for free-fall experiments.

### Description of Related Arts

Measuring local gravity by the free fall method is a traditional physics experiment and a fundamental experiment for physics courses in many universities and secondary schools. In a free fall experiment, the magnitude of gravity is generally obtained by measuring the falling distance and the falling time of, for example, a ball. Improving the efficiency of lab equipment usage and enhancing the professional skills of lab personnel have been major concerns for lab teachers, managers, and equipment manufacturers for a long time. As a key element in the informatization and digitalization of laboratory construction, the intelligent transformation of lab equipment promises to provide a more flexible and effective approach to teaching and experiments.

In the prior art, traditional free-fall experiments require operators to perform fieldwork. After each completed experiment, the operators must manually gather the balls and return them to their original positions before proceeding with the next experiment. This increases the tediousness of the experimental operation and reduces its efficiency. Additionally, when numerous repeated experiments occur, manually gathering balls may result in missing or incorrect operation.

It should be noted that the above introduction to the technical background is only provided to facilitate a clear and complete description of the technical solution of the present disclosure and to facilitate the understanding of those skilled in the art. It cannot be considered that the above technical solutions are known to those skilled in the art just because they are described in this application's background art section.

### SUMMARY

The present disclosure aims to solve the issues with the prior art by offering a ball-loading device that can automatically collect and load balls in a sequence after each ball finishes free-fall motion, thus enhancing the efficiency of free-fall experiments.

In order to achieve the above purpose, the present disclosure provides a ball-loading device for free fall experiments, which comprises an inlet tube and a shell, wherein an end of the inlet tube is connected to a first end of the shell, the shell comprises a ball channel in an interior, a second end of the shell forms a ball outlet, the first end of the shell is disposed higher than the second end of the shell, a bracket is rotatably connected to the shell, a first blocking part and a second blocking part are disposed on the bracket, the first blocking part corresponds to the ball outlet and the second blocking part corresponds to the ball channel. when the bracket rotates to different positions around the shell, the first blocking part switches to block the ball outlet, or the second blocking part switches to block the ball channel.

Preferably, the first blocking part is a long strip-shaped baffle bar, and the second blocking part is a plate-shaped baffle plate.

Preferably, a mounting slot is formed inside the shell, the baffle plate is slidably connected to the mounting slot.

Preferably, the distance between the mounting slot and the ball outlet is equal to a diameter of a single ball.

Preferably, an end of bracket is connected to a shifting rod for flipping, the shifting rod corresponds to a material flipping structure of a ball-transferring assembly.

Preferably, the ball-transferring assembly comprises a ball receiving bracket that is transferred continuously and a catcher connected to the ball receiving bracket, wherein the catcher is disposed obliquely and comprises an opening on a top end for receiving the ball, the material flipping structure comprises a contact plate connected to the ball receiving bracket, and the contact plate comprises a protruding part corresponding to the shifting rod.

Preferably, the protruding part is made of elastic material, and the elastic deformation of the protruding part is sufficient such that the material flipping structure is allowed to slide upward over the shifting rod.

The ball loading device for free fall experiments provided in this disclosure can automatically and orderly complete the free fall experiment by loading small balls in sequence and transporting them to the initial position for the next experiment. The operator does not need to operate on-site and manually collect the fallen small balls, improving the experiment's efficiency. As a remotely operated solution, the device adds a “real” experience to online experiments for students. The device proposed in the present disclosure also provides laboratory managers with a platform that can be maintained remotely, reducing work intensity, and conducts intelligent and comprehensive online experiments.

Other beneficial effects of the present disclosure will be described in detail in the subsequent specific embodiments.

### BRIEF DESCRIPTION OF THE DRAWINGS

FIG. 1 shows a schematic diagram of the ball-loading device of the present disclosure;

FIG. 2 shows a schematic diagram of the shell of the present disclosure;

FIG. 3 shows another view of the overall structure of the shell of the present disclosure;

FIG. 4 shows an exploded view of the shell of the present disclosure;

FIG. 5 shows a schematic diagram of the ball-transferring assembly of the present disclosure.

### NOTES FOR REFERENCE NUMBERS

1—Inlet tube; 2—Shell; 3—Ball; 4—Ball outlet; 5—Bracket; 6—Baffle bar; 7-—Baffle plate; 8—Mounting slot; 9—Shifting rod; 10—Ball receiving bracket; 11—Catcher; 12—Contact plate.

### DETAILED DESCRIPTION

In order to make the purpose, technical solutions, and advantages of the present disclosure more clearly understood, it is described in further detail below in conjunction with the accompanying drawings and embodiments. It should be understood that the specific embodiments described herein are intended to explain and not limit the present disclosure. The specific technical features and embodiments described in the specific embodiments can be combined in any suitable way without contradiction. For example, different embodiments can be formed by the combination of different specific technical features/embodiments, and in order to avoid unnecessary repetition, the various possible combinations of the specific technical features/embodiments in this disclosure are not described separately.

It should be noted that the terms “set” and “connect” should be understood in a broad sense. For example, they can be set, installed, and connected directly, or indirectly set and connected through the central element or centered structure. “right”, “vertical”, “horizontal”, “inside”, “outside,” etc. indicate orientation or positional relationships based on the orientation or positional relationships shown in the accompanying drawings or the conventional state of placement or use, and are intended only to facilitate and simplify the description of this disclosure, not to indicate or imply that the structure, feature, device or component referred to must have a particular orientation, be constructed and operate in a particular orientation, and therefore are not to be construed as limiting this disclosure.

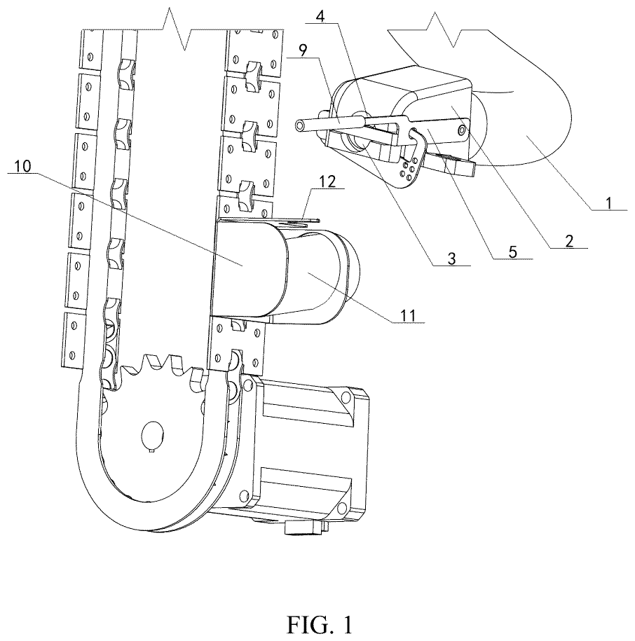

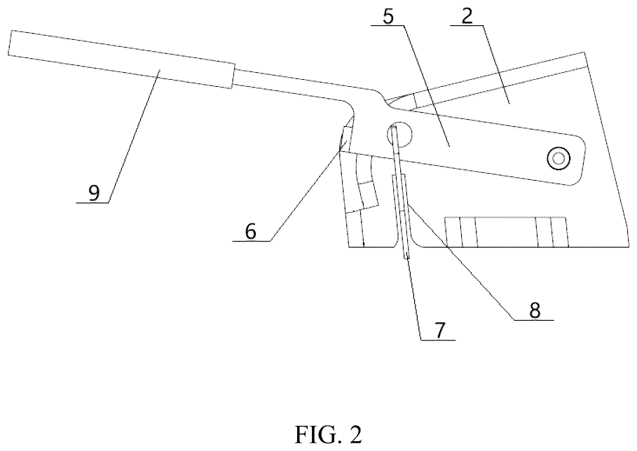

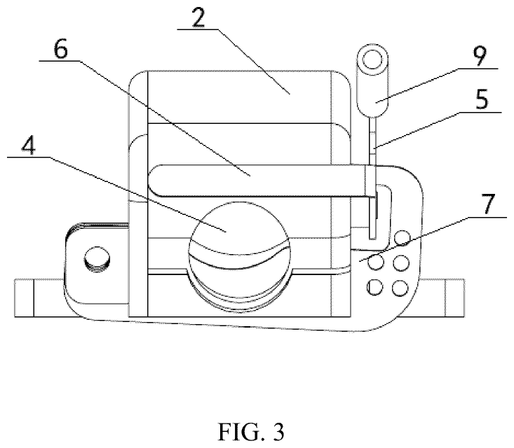

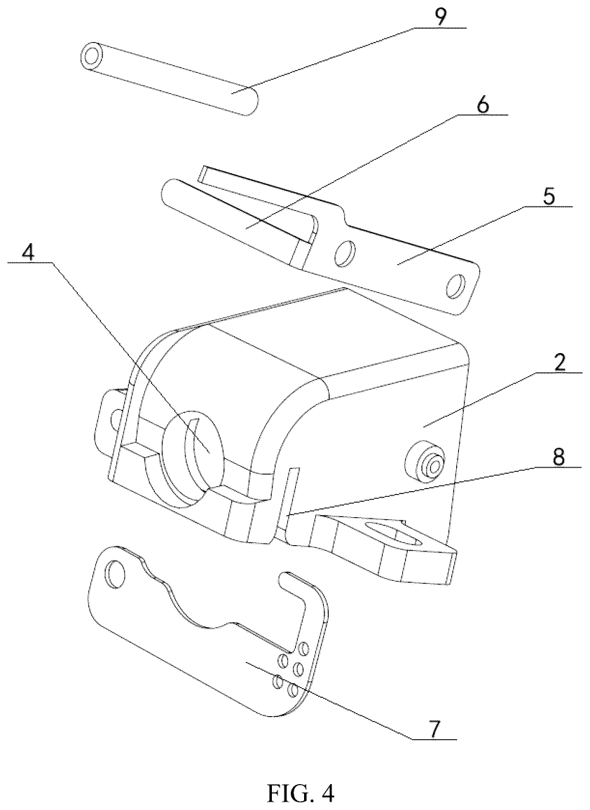

Referring to FIG. 1-FIG. 4, an embodiment of the present disclosure provides a ball-loading device for free-fall experiments, which comprises an inlet tube 1 connected to a bottom of a ball falling channel. An end of the inlet tube 1 is connected to a first end of a shell 2. After completing the free fall experiment, a ball 3 would fall into the inlet tube 1 and roll into the shell 2 along the inlet tube 1. The shell 2 comprises a ball channel interior, and a second end of the shell 2 forms a ball outlet 4. The first end of the shell 2 is disposed higher than the second end of the shell 2, such that the ball 3 would roll forward to the second end of the shell 2 in preparation for discharge.

In order to ensure orderly ball discharging, a bracket 5 is rotatably connected to the shell 2 and hinged with the shell 2 by bolts. The bracket 5 is integrally formed with a first blocking part and a second blocking part. In this embodiment, the first blocking part is a baffle bar 6 and the second blocking part is a baffle plate 7, in which the baffle bar 6 corresponds to the ball outlet 4, and the baffle plate 7 corresponds to the ball shell 2. When the bracket 5 rotates to different positions around the shell 2, the baffle bar 6 switches to block the ball outlet 4, or the baffle plate 7 switches to block the ball channel.

In this embodiment, a mounting slot 8 is disposed on a bottom part of the shell 2. The baffle plate 7 is slidably disposed in the mounting slot 8. When the ball outlet 4 is blocked by the baffle bar 6, the baffle plate 7 is integrally inserted into the mounting slot 8, allowing passage in the ball channel of the shell 2. When the bracket 5 rotates around a hinge pivot to lift the baffle bar 6, the baffle plate 7 gradually moves upward out of the mounting slot 8, thereby obstructing the passage of the ball channel.

In this embodiment, the distance between the mounting slot 8 and the ball outlet 4 is equal to a diameter of a single ball 3, so that when the baffle bar 6 is lifted, there is only one ball 3 between the baffle plate 7 and the ball outlet 4, ensuring that only a single ball 3 is discharged in each operation.

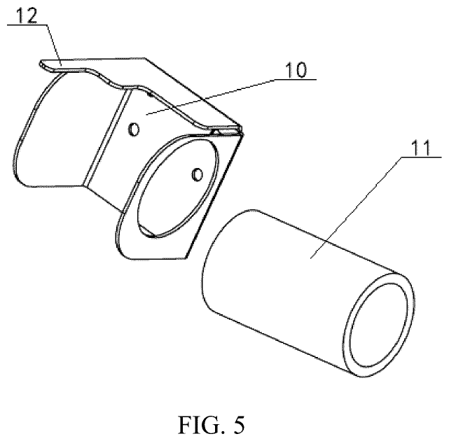

In this embodiment, an end of the bracket 5 is connected to a shifting rod 9, which corresponds to a material flipping structure of a ball-transferring assembly. As shown in FIG. 5, the ball-transferring assembly includes a ball receiving bracket 10 for continuously conveying a ball and a catcher 11 connected to the ball receiving bracket 10. The catcher 11 is also disposed obliquely and comprises an opening on a top end for receiving the ball 3. The material flipping structure comprises a contact plate 12 connected to the ball receiving bracket 10, which has a protruding part corresponding to the shifting rod 9. The protruding part is made of elastic material, the elasticity of which is sufficient to allow the material flipping structure to slide upward over the shifting rod 9.

During the continuous upward conveyance of the ball receiving bracket 10 and the ball catcher 11, the protruding part of the contact plate 12 comes into contact with the lower surface of the shifting rod 9, driving the bracket 5 to rotate, gradually lifting the baffle bar 6 thus opening the ball outlet 4. Meanwhile, the opening of the catcher 11 gradually aligns with the ball outlet 4, allowing a single one of the balls 3 near the ball outlet 4 to fall into the catcher 11, while remaining of the balls 3 is blocked by the baffle plate 7. The ball receiving bracket 10 and the catcher 11 continue to move upward, transporting the fallen ball 3 to an initial position for cycling use for the free fall experiments. When moving away from a balanced position with respect to the ball shell 2 and no longer interacting with the shifting rod 9, the bracket 5 resets under the influence of gravity, causing the baffle bar 6 to block the ball outlet 4 again, and the baffle plate 7 retracts into the mounting slot 8, opening the passage for the subsequent balls 3 to be conveyed forward a distance of a single ball 3 each time for the next ball feeding action.

The above-described embodiments are preferred embodiments of the present disclosure. It should be noted that for those skilled in the art of this technical field, various improvements and modifications are allowed to be made without departing from the principles described in the present disclosure. These improvements and modifications should also be considered within the scope of protection of the present utility model.

What is claimed is:

1. A ball-loading device for free-fall experiments, comprising an inlet tube (1) and a shell (2), wherein
an end of the inlet tube (1) is connected to a first end of the shell (2);
the shell (2) comprises a ball channel in an interior, a second end of the shell (2) forms a ball outlet (4), the first end of the shell (2) is disposed higher than the second end of the shell(2), a bracket (5) is rotatably connected to the shell (2);
a first blocking part and a second blocking part are disposed on the bracket (5), the first blocking part corresponds to the ball outlet (4), the second blocking part corresponds to the ball channel; and
when the bracket (5) rotates to different positions around the shell (2), the first blocking part switches to block the ball outlet (4), or the second blocking part switches to block the ball channel.

2. The ball-loading device of claim 1, wherein the first blocking part is a long strip-shaped baffle bar (6), and the second blocking part is a plate-shaped baffle plate (7).

3. The ball-loading device of claim 2, wherein a mounting slot (8) is formed inside the shell (2), the baffle plate (7) is slidably connected to the mounting slot (8).

4. The ball-loading device of claim 3, wherein the distance between the mounting slot (8) and the ball outlet (4) is between 1 and 1.5 times a diameter of a ball.

5. The ball-loading device of claim 1, wherein an end of bracket (5) is connected to a shifting rod (9) for flipping, the shifting rod (9) corresponds to a material flipping structure of a ball-transferring assembly.

6. The ball-loading device of claim 5, wherein the ball-transferring assembly comprises a ball receiving bracket (10) that is conveyed continuously and a catcher (11) connected to the ball receiving bracket (10), wherein the catcher (11) is disposed obliquely and comprises an opening on an top end for receiving the ball (3), the material flipping structure comprises a contact plate (12) connected to the ball receiving bracket (10), and the contact plate (12) comprises a protruding part (14) corresponding to the shifting rod (9).

7. The ball-loading device of claim 6, wherein the protruding part (14) is made of elastic material, and the elasticity of the protruding part (14) is such that the material flipping structure is allowed to slide upward over the shifting rod (9).
